(19) United States
(12) Patent Application Publication
(10) Pub. No.: US 2013/0202158 A1
(43) Pub. Date: Aug. 8, 2013

(54) IMAGE PROCESSING DEVICE, IMAGE PROCESSING METHOD, PROGRAM AND RECORDING MEDIUM

(71) Applicant: Sony Corporation, Tokyo (JP)

(72) Inventors: Yuta Nakao, Kanagawa (JP); Daisuke Nakao, Tokyo (JP)

(73) Assignee: Sony Corporation, Tokyo (JP)

(21) Appl. No.: 13/753,664

(22) Filed: Jan. 30, 2013

(30) Foreign Application Priority Data
Feb. 6, 2012 (JP) 2012-022834

(51) Int. Cl. G06T 7/20

(52) U.S. Cl. CPC G06T 7/20
USPC 382/107

(57) ABSTRACT

There is provided an image processing device that detects a plurality of moving subjects from a plurality of frames captured at a predetermined timing, selects a predetermined moving subject from the detected plurality of moving subjects, and composites images on a trajectory of the selected moving subject and a still image.

### BACKGROUND

The present disclosure relates to an image processing device, an image processing method, a program and a recording medium.

Generation of images on a trajectory of a moving subject is performed by compositing a plurality of frame images captured by an imaging device (refer to Japanese Patent Application Publication No. JP H8-182786 and Japanese Patent Application Publication No. JP 2009-181258, for example). This type of processing is called a stroboscopic effect and the like.

### SUMMARY

The technology described in Japanese Patent Application Publication No. JP H8-182786 captures an image of a background in which the moving subject does not exist. Further, an image of the moving subject is captured at the same camera angle. The moving subject is extracted by calculating a difference between the captured two images. Image capture has to be performed twice in order to extract the moving subject.

The technology described in Japanese Patent Application Publication No. JP 2009-181258 composites images at a certain frame interval. In order to composite the images in accordance with a size or the like of the moving subject, it is necessary to manually set an interval at which the images are composited. Further, the technology described in Japanese Patent Application Publication No. JP 2009-181258 displays images on trajectories of all moving subjects. It is desirable to display images on a trajectory of a predetermined moving subject, such as a moving subject desired by a user, for example.

In light of the foregoing, the present disclosure provides an image processing device, an image processing method, a program and a recording medium that composite a still image and images on a trajectory of a predetermined moving subject, among a plurality of moving subjects.

The present disclosure is provided to solve the above-mentioned issues. According to an embodiment of the present disclosure, for example, there is provided an image processing device that detects a plurality of moving subjects from a plurality of frames captured at a predetermined timing, selects a predetermined moving subject from the detected plurality of moving subjects, and composites images on a trajectory of the selected moving subject and a still image.

According to an embodiment of the present disclosure may be, for example, an image processing method, used in an image processing device, including detecting a plurality of moving subjects from a plurality of frames captured at a predetermined timing, selecting a predetermined moving subject from the detected plurality of moving subjects, and compositing images on a trajectory of the selected moving subject and a still image.

According to an embodiment of the present disclosure may be, for example, a program for causing a computer to perform an image processing method, used in an image processing device, including detecting a plurality of moving subjects from a plurality of frames captured at a predetermined timing, selecting a predetermined moving subject from the detected plurality of moving subjects, and compositing images on a trajectory of the selected moving subject and a still image.

According to at least one of the embodiments, it is possible to composite a still image and images on a trajectory of a predetermined moving subject, among a plurality of moving subjects.

### BRIEF DESCRIPTION OF THE DRAWINGS

FIG. 1 is a diagram showing an example of a configuration of an imaging device according to the present disclosure;

FIG. 2 is a diagram illustrating an example of functions of an image processing portion according to a first embodiment;

FIG. 3 is a diagram illustrating an example of a frame image;

FIG. 4 is a diagram showing an example of selection of a pixel value;

FIG. 5A is a diagram showing an example of a selection interval of the pixel value;

FIG. 5B is a diagram showing an example of the selection interval of the pixel value;

FIG. 5C is a diagram showing an example of the selection interval of the pixel value;

FIG. 6 is a diagram illustrating an example of processing that determines whether or not a predetermined pixel is a moving subject;

FIG. 7A is a diagram showing an example of a moving subject estimation map;

FIG. 7B is a diagram showing an example of a moving subject estimation map;

FIG. 8 is a diagram showing an example of a graphical user interface (GUI) that selects a moving subject;

FIG. 9 is a diagram showing another example of the GUI that selects the moving subject;

FIG. 10A is a diagram showing an example of moving subject region information;

FIG. 10B is a diagram showing an example of the moving subject region information;

FIG. 11 is a diagram illustrating an example of processing that compares the moving subject region information;

FIG. 12 is a diagram showing an example of a trajectory composite image;

FIG. 13 is a diagram showing an example of an unnatural trajectory composite image;

FIG. 14 is a diagram illustrating an example of functions of the image processing portion according to a second embodiment;

FIG. 15 is a diagram illustrating an example of functions of the image processing portion according to a third embodiment;

FIG. 16 is a diagram showing an example of a trajectory composite image; and

FIG. 17 is a diagram showing an example of a GUI that sets an interval of moving subjects in images on a trajectory.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the explanation will be made in the following order.

1. First embodiment

2. Second embodiment

3. Third embodiment

4. Modified examples

Note that the embodiments etc. described below are exemplary specific examples of the present disclosure and the content of the present disclosure is not limited to these embodiments etc.

### 1. FIRST EMBODIMENT (CONFIGURATION OF IMAGING DEVICE)

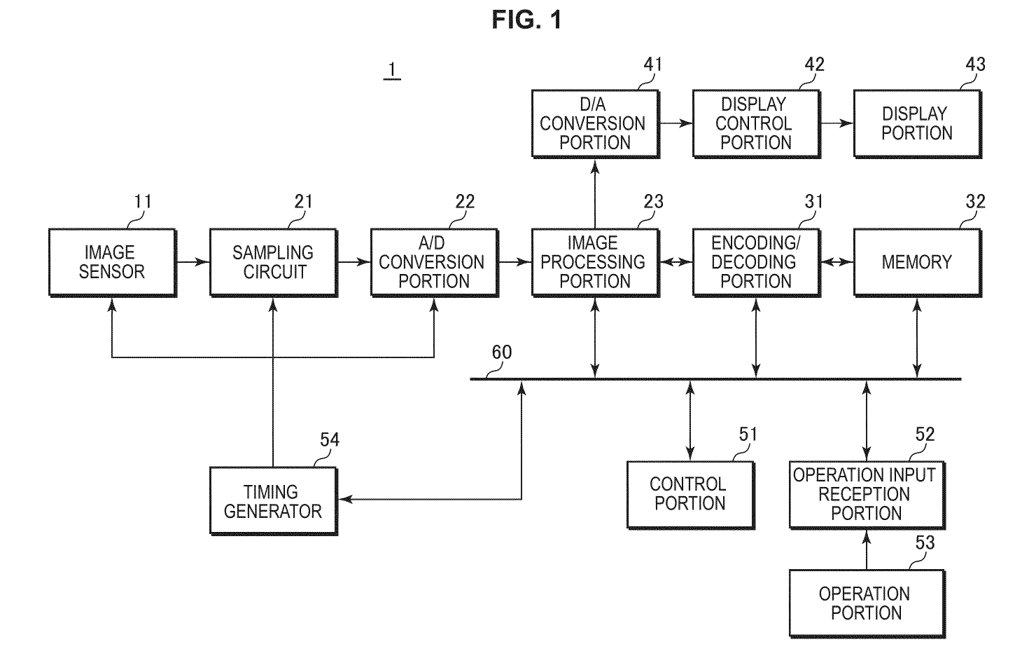

FIG. 1 shows an example of a configuration of an imaging device. An imaging device 1 is used to perform an image capturing operation in which, for example, images of predetermined subjects are captured for a predetermined time period and moving images are obtained. The predetermined subjects include a still subject that does not move at all, and a moving subject that is a photographic subject that moves. The still subject is a background, such as a tree, a road and a building, for example. The moving subject is a person, a vehicle, an animal, a ball or the like. It is not necessary for the moving subject to constantly move, and the moving subject may be in a temporarily stopped state.

The imaging device 1 is mainly configured by an optical system, a signal processing system, a recording/playback system, a display system and a control system. For example, the configuration of the optical system corresponds to an imaging portion.

The optical system includes a lens and an aperture (which are not shown in the drawings), and an image sensor 11. An optical image from a subject is brought into focus by the lens. The amount of light of the optical image is adjusted by the aperture. The focused optical image is supplied to the image sensor 11. The optical image is photoelectrically converted by the image sensor 11 and analog image data, which is an electrical signal, is generated. The image sensor 11 is a charge coupled device (CCD) sensor, a complementary metal oxide semiconductor (CMOS) sensor, or the like.

The signal processing system includes a sampling circuit 21, an analog to digital (A/D) conversion portion 22 and an image processing portion 23. The sampling circuit 21 improves a signal to noise (S/N) ratio by performing correlated double sampling (CDS) processing, for example, on the analog image data supplied from the image sensor 11. In the sampling circuit 21, analog signal processing, such as automatic gain control (AGC) that controls a gain, may be performed on the analog image data.

The A/D conversion portion 22 converts the analog image data that is supplied from the sampling circuit 21 into digital image data. The converted digital image data is supplied to the image processing portion 23.

The image processing portion 23 performs camera signal processing, such as mosaic processing, auto focus (AF), auto exposure (AE), and auto white balance (AWB) etc., on the digital image data. Further, the image processing portion 23 performs processing that generates a trajectory composite image by compositing a still image and images on a trajectory of a predetermined moving subject, and processing to display a graphical user interface (GUI). Note that an image processing portion that performs the camera signal processing, and an image processing portion that performs the processing that generates the trajectory composite image and other processing may be separately provided. Although omitted from the drawings, the image processing portion 23 includes an image memory that holds a plurality of frame images.

The recording/playback system includes an encoding/decoding portion 31 and a memory 32. The memory 32 includes a memory and a driver that controls recording processing and playback processing with respect to the memory. When the digital image data is recorded, the digital image data supplied from the image processing portion 23 is encoded into a predetermined format by the encoding/decoding portion 31. The encoded digital image data is recorded in the memory 32. When the digital image data is played back, predetermined digital image data is read out from the memory 32. The read digital image data is decoded by the encoding/decoding portion 31.

The memory 32 is, for example, a hard disk that is built into the imaging device 1. The memory 32 may be a memory that can be freely inserted into and removed from the imaging device 1, such as a semiconductor memory, an optical desk or a magnetic disk. For example, the digital image data is recorded in the memory 32. Meta data, such as an image capture date and time of the digital image data, and audio data may be recorded in the memory 32.

The display system includes a digital to analog (D/A) conversion portion 41, a display control portion 42 and a display portion 43. The D/A conversion portion 41 converts the digital image data supplied from the image processing portion 23 into analog image data. The digital image data may be digital image data that is taken in by the optical system and converted by the A/D conversion portion 22, or may be the digital image data read out from the memory 32.

The display control portion 42 converts the analog image data supplied from the D/A conversion portion 41 to a video signal in a predetermined format. The predetermined format is a format compatible with the display portion 43. The video signal is supplied from the display control portion 42 to the display portion 43 and display based on the video signal is performed on the display portion 43.

The display portion 43 is formed by a liquid crystal display (LCD), an organic electroluminescence (EL) display or the like. The display portion 43 functions as a finder that displays a through image, for example. The image played back from the memory 32 may be displayed on the display portion 43. The display portion 43 may be formed as a touch panel. An operation screen, such as a menu screen, may be displayed on the display portion 43, and an operation with respect to the imaging device 1 may be performed by touching a predetermined position on the operation screen. A GUI to select the predetermined moving subject from among a plurality of moving subjects may be displayed on the display portion 43.

The control system includes a control portion 51, an operation input reception portion 52, an operation portion 53 and a timing generator 54. The control portion 51 is formed by a central processing unit (CPU), for example, and controls the respective portions of the imaging device 1. The operation input reception portion 52 receives an operation performed on the operation portion 53, and generates an operation signal in accordance with the operation. The generated operation signal is supplied to the control portion 51. The control portion 51 performs processing in accordance with the operation signal.

The operation portion 53 is a button, a switch or the like that is disposed on the imaging device 1. For example, the operation portion 53 is a power on/off button or a recording button to perform image capture. The number of the operation portions 53, a position at which the operation portion 53 is disposed, and the shape etc. of the operation portion 53 can be changed as appropriate.

The timing generator 54 generates a predetermined timing signal in accordance with control by the control portion 51. The generated timing signal is supplied to the image sensor 11, the sampling circuit 21 and the A/D conversion portion 22. The image sensor 11 and the like respectively operate in response to the supplied timing signal.

The structural elements of the control system, the image processing portion 23, the encoding/decoding portion 31 and the memory 32 are connected via a bus 60. For example, a control command sent from the control portion 51 is transmitted via the bus 60. The timing signal generated by the timing generator 54 may be supplied to the imaging processing portion 23 and the encoding/decoding portion 31 via the bus 60. The image processing portion 23 and the like may operate in response to the timing signal.

Although omitted from the drawings, an audio processing system that processes audio collected by a microphone may be provided in the imaging device 1. Further, a speaker that plays back the collected audio or plays back background music (BGM) may be provided on the imaging device 1.

An example of an operation of the imaging device 1 will be explained in outline. The optical system operates in response to the timing signal supplied from the timing generator 54, and a plurality of frame images are taken in via the optical system. The plurality of frame images are taken in based on a certain frame rate. The certain frame rate differs for each imaging device. The frame rate is 10 frames per second (f/s), 30 f/s, 60 f/s, 240 f/s, or the like.

Predetermined signal processing is performed by the sampling circuit 21 on the analog image data taken in via the optical system, such as the image sensor 11. The analog image data is converted into digital image data by the A/D conversion portion 22. The digital image data is supplied to the image processing portion 23. In a normal state, the digital image data supplied to the image processing portion 23 is overwritten on the image memory included in the image processing portion 23. Processing by the D/A conversion portion 41 and the display control portion 42 is performed on the image data stored in the image memory, and a through image is displayed on the display portion 43.

Here, if a composition of the moving subject is decided and the recording button of the operation portion 53 is depressed, image capture processing is performed. The image capture processing is performed for a predetermined time period until the recording button is depressed again, for example. By the image capture processing, a plurality of pieces of image data are stored in the image memory of the image processing portion 23. For example, at a timing at which the image capture processing is complete, the image data is transferred from the image memory to the encoding/decoding portion 31. Then, the image data is encoded by the encoding/decoding portion 31. The encoded image data is recorded in the memory 32.

For example, a stroboscopic imaging mode can be set for the imaging device 1. When the stroboscopic imaging mode is set, processing is performed using the plurality of frame images stored in the image processing portion 23. By this processing, a still image and images on the trajectory of the predetermined moving subject are composited and a trajectory composite image is generated. The trajectory composite image is displayed on the display portion 43, for example. Note that this processing will be described in more detail later.

(Functions of Image Processing Portion)

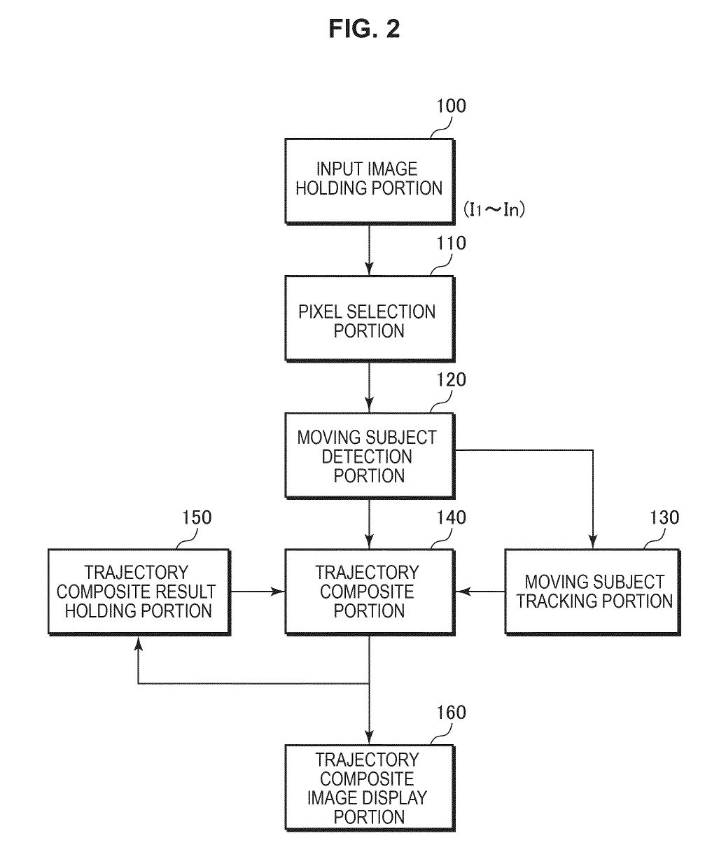

FIG. 2 is a functional block diagram showing an example of functions of the image processing portion 23. The image processing portion 23 includes, as an example of the functions, an input image holding portion 100, a pixel selection portion 110, a moving subject detection portion 120, a moving subject tracking portion 130, a trajectory composite portion 140, a trajectory composite result holding portion 150 and a trajectory composite image display portion 160.

(Input Image Holding Portion)

The input image holding portion 100 is an image memory that holds (stores) a plurality of frame images. n (n is an integer of two or more) frame images that are captured in chronological order are stored in the input image holding portion 100. The storage capacity of the input image holding portion 100 is limited. Therefore, when a new frame image is input to the input image holding portion 100, the oldest frame image among the stored frame images is sequentially deleted and overwritten. The frame images that are obtained by performing image capture for a certain time period are held in the input image holding portion 100.

Note that, in the explanation below, for convenience of explanation, the frame rate of the imaging device 1 is assumed to be 60 f/s. For example, image capture is performed for 10 seconds using the imaging device 1. In this case, 600 frames of frame images (I₁ to I₆₀₀) are held in the input image holding portion 100. Of course, the frame rate and the time period during which image capture is performed are only examples, and are not limited to the above-described numeric values.

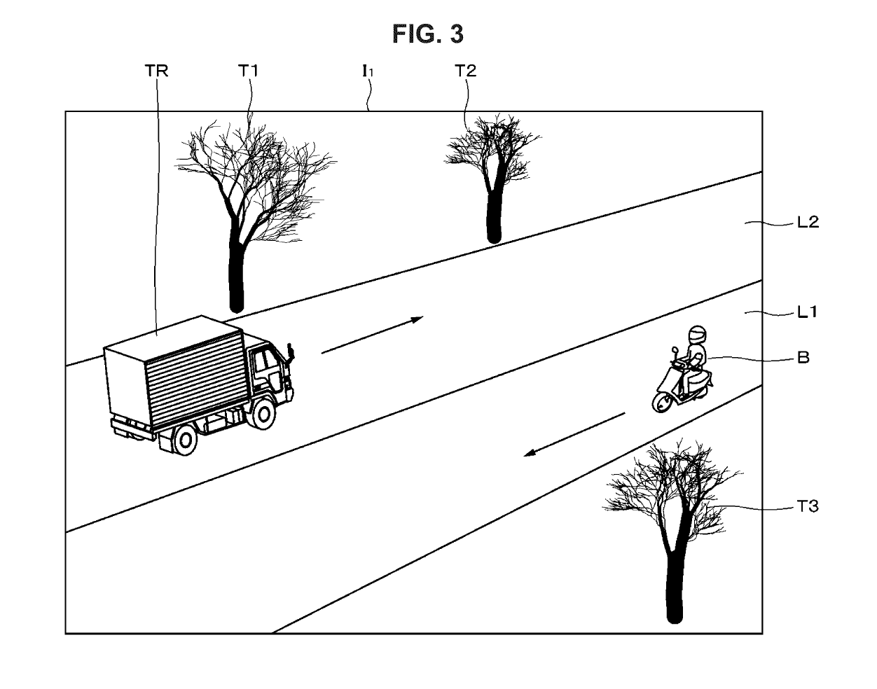

FIG. 3 shows an example of the first frame image I₁ that is held by the input image holding portion 100. The frame image I₁ includes, as a background, a tree T1, a tree T2, a tree T3, a traveling lane L1 and a traveling lane L2, for example. Moving subjects are, for example, a motorcycle B (including a driver) traveling on the lane L1 and a truck TR traveling on the lane L2. The motorcycle B is located at a right end portion of the frame image I₁, as viewed in FIG. 3. The truck TR is located at a left end portion of the frame image I₁, as viewed in FIG. 3.

When the frame image I₁ to the frame image I₆₀₀ are played back in chronological order, the motorcycle B moves on the lane L1 from the right side toward the vicinity of the lower left corner. In other words, the motorcycle B moves to approach the imaging device 1 along with the elapse of time. The apparent size of the motorcycle B increases along with the elapse of time. The truck TR moves on the lane L2 from the vicinity of the lower left corner toward the vicinity of the upper right corner. In other words, the truck TR moves away from the imaging device 1 along with the elapse of time. The apparent size of the truck TR decreases along with the elapse of time.

(Pixel Selection Portion)

The pixel selection portion 110 sets one of the frame images as a center image, from among the frame images held in the input image holding portion 100. Further, using the center image as a reference, the pixel selection portion 110 sets frame images within a certain range in chronological order, as surrounding images. Note that the surrounding images may be images located before or after the center image in terms of time, or may include images located before and after the center image in terms of time. The center image and the surrounding images are taken as processing target images.

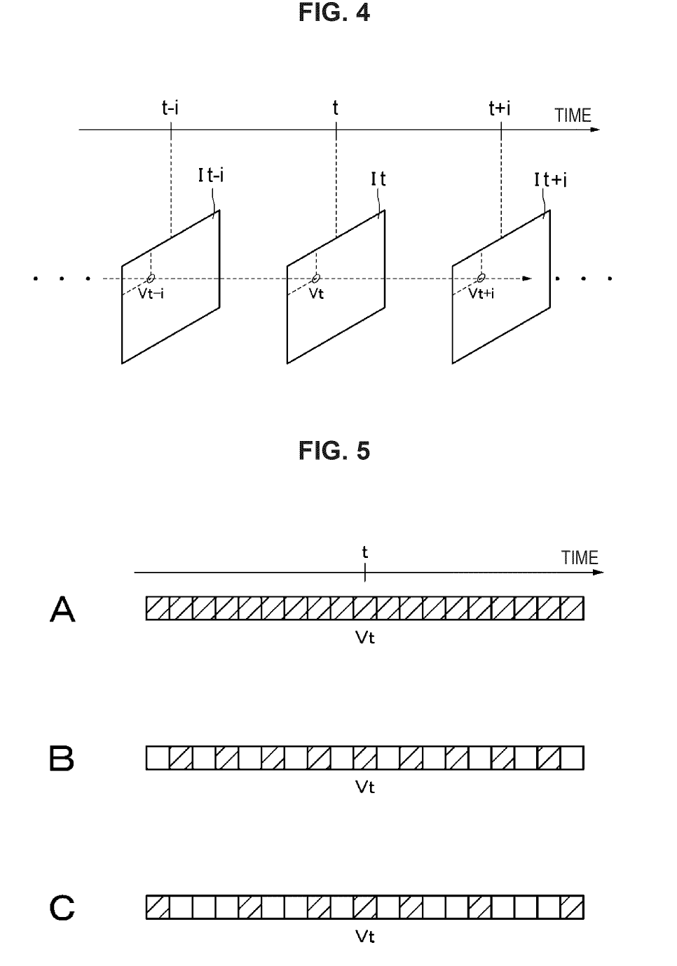

As shown in FIG. 4, a frame image Iₜ at a time t, for example, is set as the center image. A frame image Iₜ₊ᵢ at a time t+i and a frame image Iₜ₋ᵢ at a time t−i are set as the surrounding images. Note that the number of the surrounding images is not limited to two, and any number can be set. Frame images within a predetermined time period (for example, three seconds) are set as the surrounding images with respect to the center image. Therefore, there are cases in which the number of the surrounding images is about 200 frames. However, for the convenience of explanation, the number of the surrounding images is reduced.

The pixel selection portion 110 selects a pixel Vₜ at a predetermined position of the center image Iₜ and acquires the pixel value of the pixel Vₜ. The pixel selection portion 110 acquires the pixel value of a pixel V, at the same position as the pixel Vₜ in the surrounding image Iₜ₊ᵢ. The pixel selection portion 110 acquires the pixel value of the pixel Vₜ₋ᵢ at the same position as the pixel Vₜ in the surrounding image Iₜ₋ᵢ.

Note that a pixel selection interval in the surrounding images can be changed as appropriate. FIG. 5 shows a plurality of examples of the pixel selection interval. In the examples shown in FIG. 5, nine frame images located after the center image in terms of time are set as the surrounding images. Further, nine frame images located before the center image in terms of time are set as the surrounding images. The pixel Vₜ at the predetermined position of the center image, and the pixels in the surrounding images that are located at the same position as the pixel Vₜ are shown by rectangular blocks. Oblique lines added to the blocks indicate pixels that are selected as processing targets. Note that the pixel value of the pixel Vₜ is referred to as the pixel value V, as appropriate.

FIG. 5A shows an example in which the pixels in the surrounding images that are located at the same position as the pixel Vₜ are all selected. In this case, detection accuracy of the moving subject is improved, the detection being performed by the moving subject detection portion 120 to be described later. However, a calculation cost is increased. Therefore, selection may be performed by thinning out the pixels, as shown in FIG. 5B and FIG. 5C. FIG. 5B shows an example in which the selection is performed such that the pixels in the surrounding images that are located at the same position as the pixel Vₜ are thinned out at an equal interval. FIG. 5C shows an example in which the pixels of the surrounding images that are close to the center image in terms of time are densely selected. In this manner, the selection may be performed by thinning out the pixels of the surrounding images, taking into consideration the calculation cost to detect the moving subject.

(Moving Subject Detection Portion)

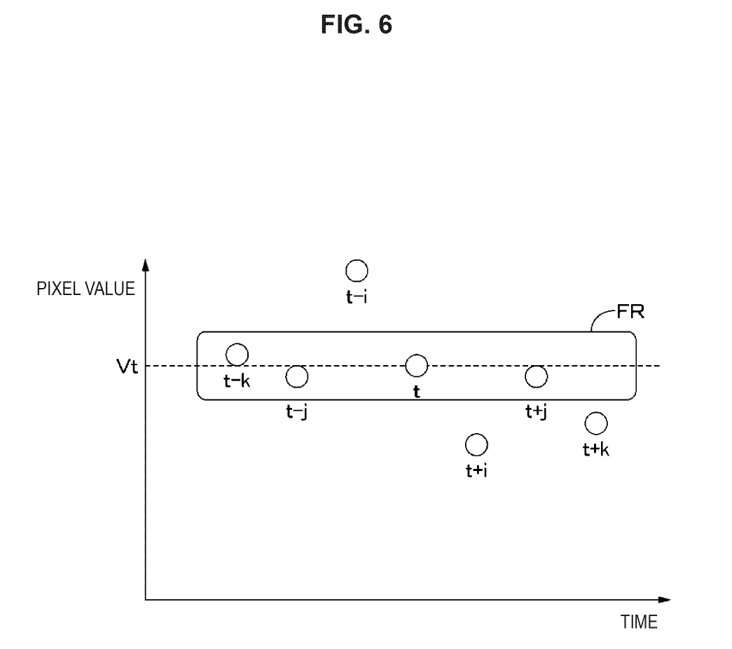

When the pixel selection is performed by the pixel selection portion 110, processing by the moving subject detection portion 120 is performed. As shown in FIG. 6, the pixel values of the pixels selected by the pixel selection portion 110 are plotted using a time axis and a pixel value axis. In the example shown in FIG. 6, the pixel value Vₜ of the pixel Vₜ at the predetermined position of the center image is plotted. Further, in each of six surrounding images, the pixel value of the pixel that is located at the same position as the pixel Vₜ is plotted. A predetermined range (a determination threshold value range) is set using the pixel value Vₜ as a reference. The determination threshold value range is schematically shown by a frame FR.

The moving subject detection portion 120 performs majority decision processing with respect to the number of pixels within the determination threshold value range, and thereby determines whether or not the pixel Vₜ is a background pixel included in the background. For example, it is assumed that the larger the number of pixels having pixel values within the determination threshold value range, the smaller the pixel value change, and in this case, it is determined that the pixel Vₜ is a background pixel. It is assumed that the smaller the number of pixels having pixel values within the determination threshold value range, the larger the pixel value change, and in this case, it is determined that the pixel Vₜ is a pixel of the moving subject. The determination may also be performed such that, first, it is determined whether or not the pixel Vₜ is a background pixel and then pixels that are not determined as background pixels may be determined as pixels of the moving subject.

When the determination with respect to the pixel Vₜ is complete, the next pixel in the center image is selected by the pixel selection portion 110. For example, a raster scan order is used to sequentially select the pixels in the center image. More specifically, the pixels are sequentially selected from the upper left pixel of the center image toward the lower right pixel. It is determined whether or not each of the selected pixels is a background pixel. When the determination is complete for all the pixels in the center image, the frame image next to the center image in terms of time is set as a center image. The above-described processing is performed for all the pixels in the newly set center image, and it is determined whether or not each of the selected pixels is a background pixel.

When the frame images of 600 frames are held in the input image holding portion 100, first, the frame image I₁, for example, is set as the center image. The determination processing by the moving subject detection portion 120 is performed for all the pixels in the frame image I₁. Next, the second frame image I₂ is set as the center image, and the determination processing by the moving subject detection portion 120 is performed for all the pixels in the frame image I₂. This processing is repeated until the determination processing that determines whether or not each pixel is a background pixel is performed for all the pixels in the 600^{th} frame image I₆₀₀. The determination processing that determines whether or not each pixel is a background pixel is performed for all the pixels in the 600 frames.

Note that the processing target frame images may be reduced by thinning out the frame image at a predetermined interval from the frame images held in the input image holding portion 100. By reducing the processing target frame images, it is possible to reduce processing loads on the pixel selection portion 110 and the moving subject detection portion 120.

The moving subject detection portion 120 generates a moving subject estimation map Mₙ for each of the frame images, in accordance with a result of the determination processing for each pixel. The moving subject estimation map Mₙ is a map to identify the moving subject and the background image. For example, the moving subject estimation map Mₙ is represented by binary information composed of low-level pixels and high-level pixels.

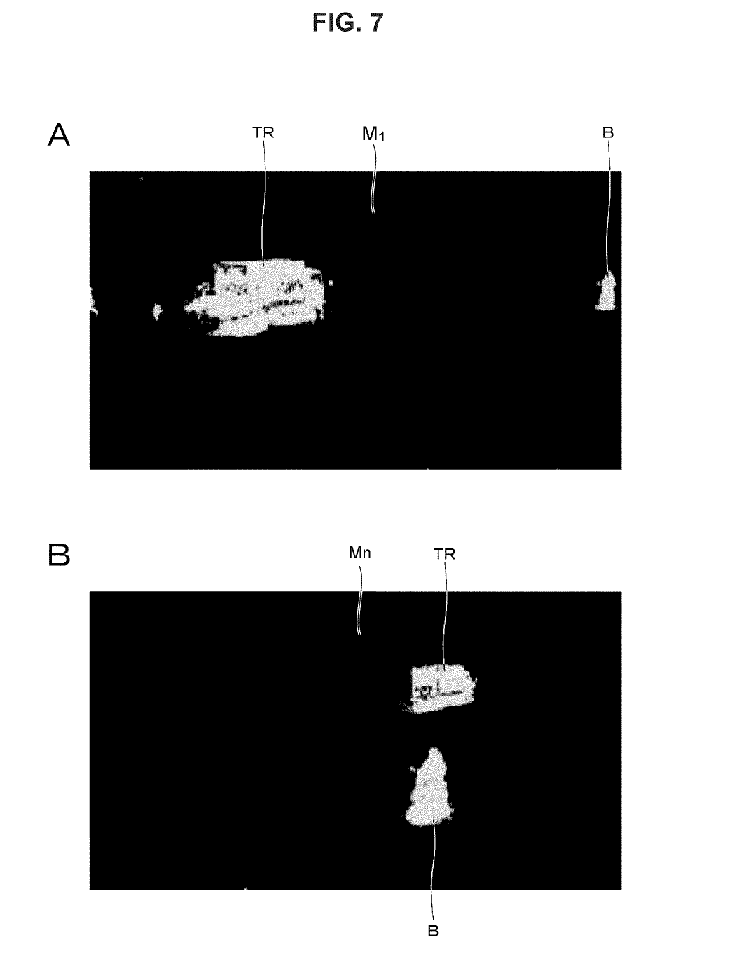

FIG. 7A shows an example of a moving subject estimation map M₁ that is obtained by the determination processing for the frame image I₁. Pixels that are determined as background pixels by the determination processing by the moving subject detection portion 120 are shown as low level pixels (shown in black, for example). Pixels that are not determined as background pixels, namely, pixels included in the moving subject are shown as high level pixels (shown in white, for example). The motorcycle B is detected as a moving subject in the vicinity of a right end portion of the moving subject estimation map M₁. The truck TR is detected as a moving subject in the vicinity of a left end portion of the moving subject estimation map M₁.

FIG. 7B shows an example of the moving subject estimation map Mₙ corresponding to a frame image Iₙ, which is located after the frame image I₁ in terms of time by a predetermined time. Since the motorcycle B approaches with the elapse of time, the region indicating the motorcycle B increases. Meanwhile, since the truck TR moves away with the elapse of time, the region indicating the truck TR decreases. The moving subject estimation map Mₙ generated by the moving subject detection portion 120 is supplied to the moving subject tracking portion 130.

Note that the processing that detects the moving subject is not limited to the above-described processing. For example, as disclosed in the above-described Japanese Patent Application Publication No. JP 2009-181258 (published by the Japan Patent Office), the probability of being the moving subject may be calculated for each pixel, taking a distance between the pixels into consideration. The moving subject may be detected by comparing a predetermined frame and frames that are located before and after the predetermined frame in terms of time. A distance map may be obtained with respect to the frame images, and the subject located to the front may be determined as the moving subject. In this manner, the method for detecting the moving subject is not limited to the above-described method and a known method can be used.

From among the plurality of moving subjects detected by the moving subject detection portion 120, the moving subject as a tracking target is selected. A still image and images on a trajectory of the selected moving subject are composited by the processing to be described later, and a trajectory composite image is obtained. Note that, from among the plurality of moving subjects detected by the moving subject detection portion 120, one moving subject may be selected or a plurality of moving subjects may be selected. All the moving subjects detected by the moving subject detection portion 120 may be selected. In a first embodiment, the moving subject chosen by a user is selected.

The moving subject is selected using a GUI, for example. The GUI is displayed on the display portion 43, for example. Processing that generates the GUI is performed by the image processing portion 23, for example. The processing that generates the GUI may be performed by the control portion 51 etc.

For example, the first frame image I₁ is used as the GUI. Of course, any frame image may be used. All the moving subjects detected by the moving subject detection portion 120 may be displayed, and an image to select the moving subject may be newly generated.

The image processing portion 23 identifies a position of the moving subject based on the moving subject estimation map M₁ exemplified in FIG. 7A. For example, the image processing portion 23 identifies coordinates of a pixel located in the vicinity of an end portion, inside the white region in the moving subject estimation map M₁. Then, the image processing portion 23 generates an image of a selection region to select the moving subject. The image of the selection region is, for example, an image that indicates the moving subject and has a predetermined region. The generated image of the selection region is superimposed on the frame image I₁ and the selection region is displayed on the screen.

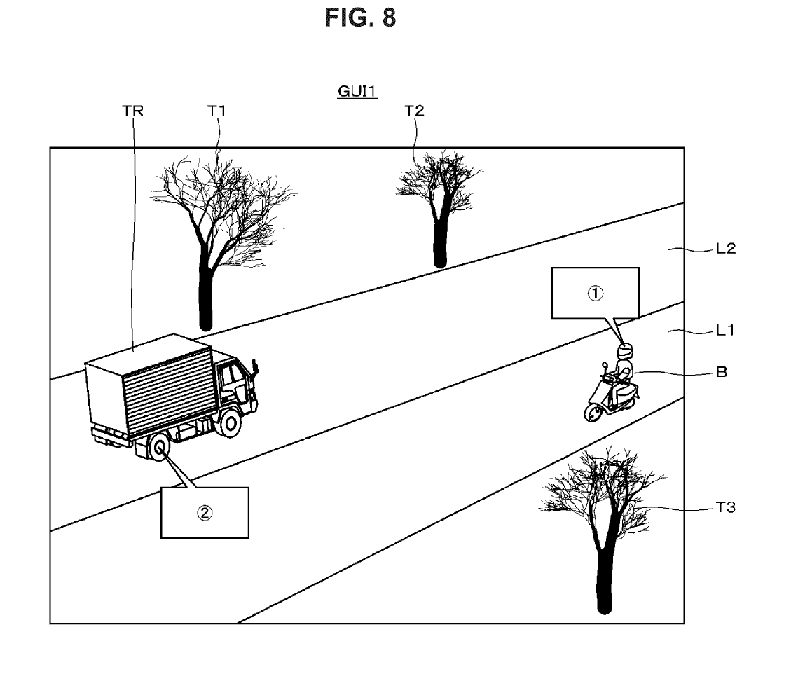

FIG. 8 shows an example of a GUI to select the moving subject. Selection regions corresponding to the respective moving subjects are displayed in a graphical user interface GUI1. For example, a selection region 1 is displayed to indicate the vicinity of an end portion of the motorcycle B. Further, a selection region 2 is displayed to indicate the vicinity of an end portion of the truck TR. The shape and the size of the selection region 1 are substantially the same as those of the selection region 2. The user performs a selection operation using his/her finger or an operation tool, and selects at least one of the selection region 1 or the selection region 2. For example, a selection operation is performed in which at least one of the selection region 1 or the selection region 2 is touched. At least one of the motorcycle B or the truck TR is selected by the selection operation. The selected moving subject is taken as a tracking target.

Note that the shape of the selection region is not limited to a rectangle and may be a circle or the like. The size etc. of the selection region is appropriately set so that the user can accurately designate the selection region. Of course, a button or a cross key may be used to designate the selection region. Further, other buttons etc., such as an OK button to confirm the selection of the moving subject, may be displayed.

The moving subjects have a variety of shapes, sizes and speeds. Depending on the shape etc. of the moving subject, it may be difficult to accurately touch the moving subject itself. However, since the selection regions having an appropriate shape and size are displayed, the user can select the moving subject accurately and easily.

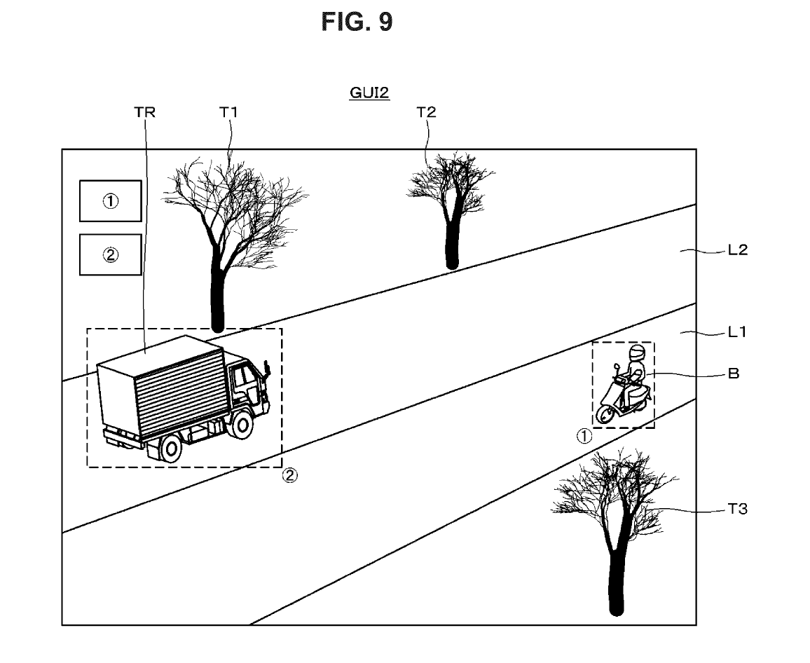

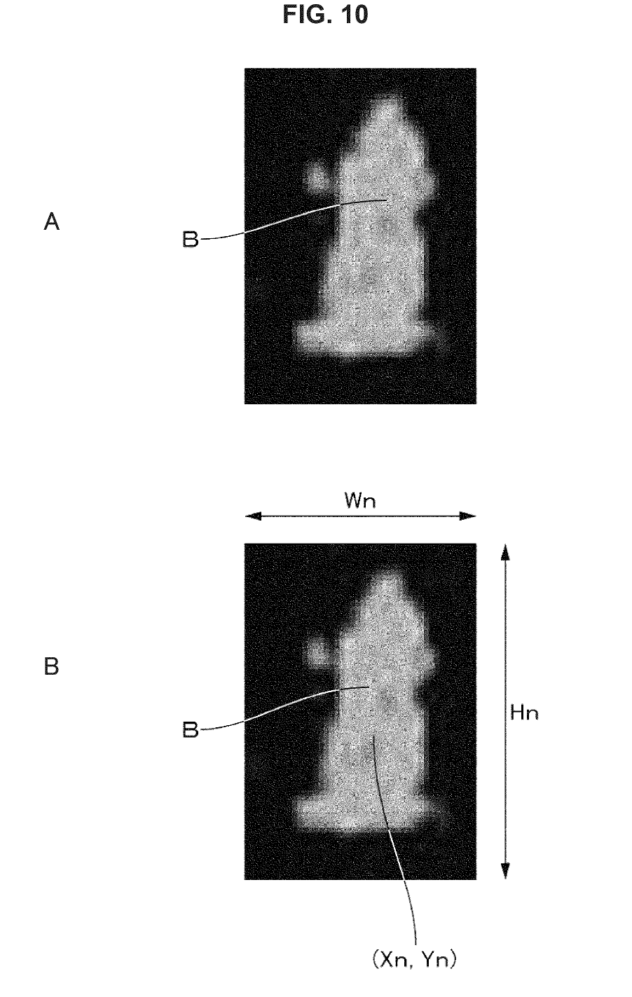

FIG. 9 shows another example of the GUI to select the moving subject. In a graphical user interface GUI2, a number is assigned to each of the moving subjects and the number is displayed in the vicinity of each of the moving subjects. For example, the number 1 is assigned to the motorcycle B and the number 1 is displayed in the vicinity of the motorcycle B. For example, the number 2 is assigned to the truck TR and the number 2 is displayed in the vicinity of the truck TR. Each of the moving subjects is surrounded by dotted lines in order to clarify the range of each of the moving subjects. The size of the rectangular region set by the dotted lines is determined by, for example, referring to the moving subject estimation map M₁. Note that the dotted lines need not necessarily be displayed.

Selection regions corresponding to the numbers assigned to the respective moving subjects are displayed in the graphical user interface GUI2. For example, the selection region 1 corresponding to the motorcycle B and the selection region 2 corresponding to the truck TR are displayed. The selection region 1 and the selection region 2 are superimposed on a background region. For example, in the graphical user interface GUI2, the selection region 1 and the selection region 2 are displayed close to each other in the background region in the vicinity of the upper left corner.

The graphical user interface GUI2 is not limited to a still image and may be a moving image. Further, the selection region 1 and the selection region 2 may be displayed in a region that is constantly the background region. Even when the graphical user interface GUI2 is a moving image, the selection region 1 and the selection region 2 can be displayed without obstructing the display of the motorcycle B and the truck TR. Further, even when the graphical user interface GUI2 is a moving image, the selection regions themselves are fixed and thus an operation on each of the selection regions can be performed easily. Note that, although the background is displayed in the graphical user interfaces GUI1 and GUI2, only the moving subjects may be displayed as selection candidates. The selection of the moving subject may be allowed by designating the region within the dotted lines.

The selection operation with respect to the moving subject is performed using the graphical user interfaces GUI1 and GUI2 etc. Hereinafter, if not otherwise designated, the explanation will be made assuming that the selection region 1 is touched and the motorcycle B is selected. Information indicating that the motorcycle B has been selected (which is hereinafter referred to as moving subject selection information, as appropriate) is supplied to the moving subject tracking portion 130.

(Moving Subject Tracking Portion)

The moving subject tracking portion 130 sets, as a tracking target, the moving subject designated by the moving subject selection information. More specifically, the moving subject tracking portion 130 selects the motorcycle B from each of the moving subject estimation maps (M₁ to M₆₀₀) that are supplied to the moving subject tracking portion 130. The moving subject tracking portion 130 acquires a position and a size of the extracted motorcycle B.

FIG. 10A shows a region corresponding to the motorcycle B extracted from the predetermined moving subject estimation map Mₙ. The region corresponding to the motorcycle B is defined, for example, as a rectangular region that is set to include a region (a white region) indicating the motorcycle B. The region corresponding to the motorcycle B is referred to as a moving subject region, as appropriate.

As shown in FIG. 10B, a position and a size of the moving subject region are acquired. The position of the moving subject region is defined by, for example, coordinates (Xₙ, Yₙ) at which the center of gravity of the moving subject region in the moving subject estimation map Mₙ is located. The size of the moving subject region is defined by a length Wₙ in the horizontal direction and a length Hₙ in the vertical direction. The moving subject tracking portion 130 supplies information relating to the position and the size of the moving subject region to the trajectory composite portion 140. Note that the information relating to the position and the size of the moving subject region that is acquired from the moving subject estimation map Mₙ is referred to as moving subject region information IFₙ, as appropriate. Note that the truck TR is not the selected moving subject, and therefore it is not necessary to acquire moving subject information of the truck TR.

(Trajectory Composite Portion)

The trajectory composite portion 140 refers to the moving subject region information that is supplied from the moving subject tracking portion 130 and the trajectory composite result holding portion 150, and thereby determines whether to hold or discard a frame image. When it is determined that a frame image is to be held, the frame image is held in the trajectory composite result holding portion 150. At this time, information of the moving subject region corresponding to the frame image is also held. When it is determined that a frame image is to be discarded, the frame image and the moving subject region information corresponding to the frame image are discarded. Further, the trajectory composite portion 140 composites a still image and images on the trajectory of the moving subject.

(Trajectory Composite Result Holding Portion)

The trajectory composite result holding portion 150 holds the frame image and the moving subject region information corresponding to the frame image supplied from the trajectory composite portion 140. The trajectory composite result holding portion 150 supplies the moving subject region information held therein to the trajectory composite portion 140.

(Trajectory Composite Image Display Portion)

The trajectory composite image display portion 160 displays a trajectory composite image that is supplied from the trajectory composite portion 140. The trajectory composite image may be either a still image or a moving image. The trajectory composite image display portion 160 may be the display portion 43, or may be a display device that is provided separately from the imaging device 1.

(Processing Flow of Image Processing Portion)

An example of a processing flow of the image processing portion 23 will be explained. For example, 600 frames of the frame images (I₁ to I₆₀₀) are held in the input image holding portion 100. The processing by the pixel selection portion 110 and the moving subject detection portion 120 is performed on the first frame image I₁ and the moving subject estimation map M₁ corresponding to the frame image I₁ is acquired. The processing by the pixel selection portion 110 and the moving subject detection portion 120 is described in detail above, and a redundant explanation thereof is thus omitted. The frame image I₁ is supplied to the trajectory composite portion 140. The moving subject estimation map M₁ is supplied to the moving subject tracking portion 130. Further, the moving subject selection information indicating that the motorcycle B has been selected is supplied to the moving subject tracking portion 130.

The moving subject tracking portion 130 extracts the moving subject region of the motorcycle B from the moving subject estimation map M₁, and acquires moving subject region information IF₁. The moving subject region information IF₁ is supplied to the trajectory composite portion 140.

The trajectory composite portion 140 supplies, to the trajectory composite result holding portion 150, the frame image I₁ that is supplied first, and the moving subject region information IF₁ that is supplied first. The frame image I₁ and the moving subject region information IF₁ are held in the trajectory composite result holding portion 150. The frame image I₁ that is held in the trajectory composite result holding portion 150 is taken as an example of a reference frame (which is also referred to as a key frame). In the subsequent processing, the moving subject region information corresponding to the reference frame is supplied to the trajectory composite portion 140. The reference frame is updated in a manner to be described later.

Next, the second frame image I₂ is read out from the input image holding portion 100, as a comparison target frame (which is also referred to as a current frame). The processing by the pixel selection portion 110 and the moving subject detection portion 120 is performed on the frame image I₂, and a moving subject estimation map M₂ corresponding to the frame image I₂ is acquired. The frame image I₂ is supplied to the trajectory composite portion 140. The moving subject estimation map M₂ corresponding to the frame image I₂ is supplied to the moving subject tracking portion 130.

The moving subject tracking portion 130 extracts the moving subject region of the motorcycle B from the moving subject estimation map M₂, and acquires moving subject region information IF₂. The moving subject region information IF₂ is supplied to the trajectory composite portion 140.

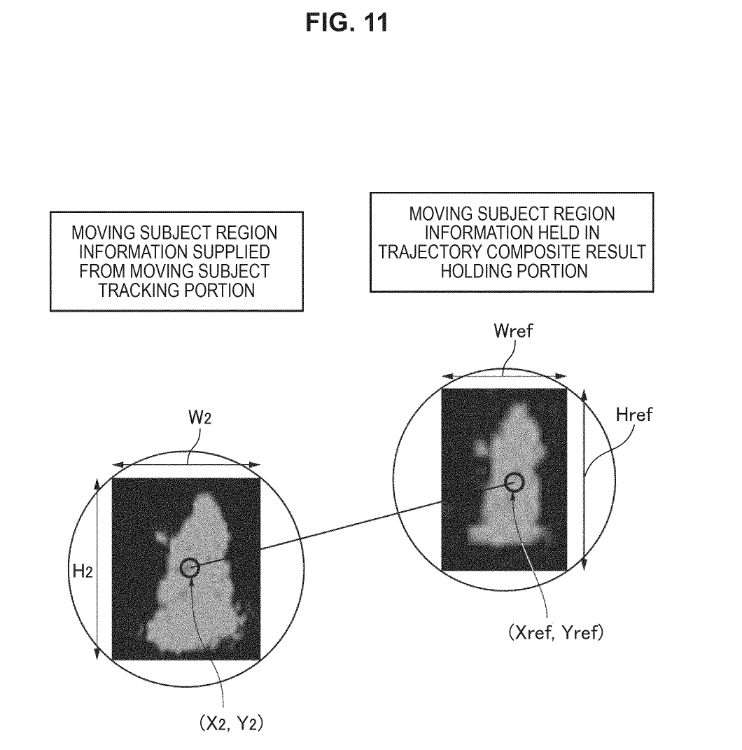

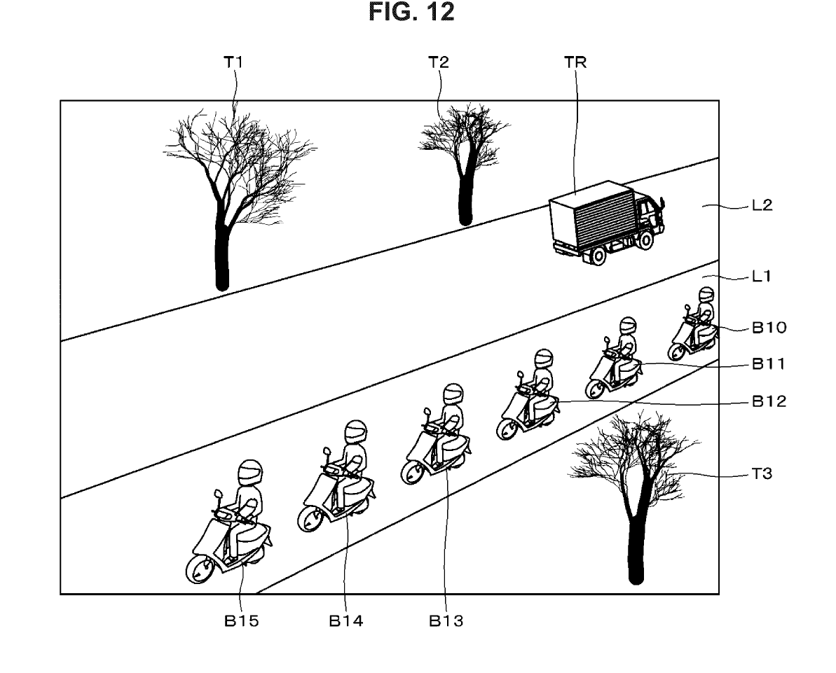

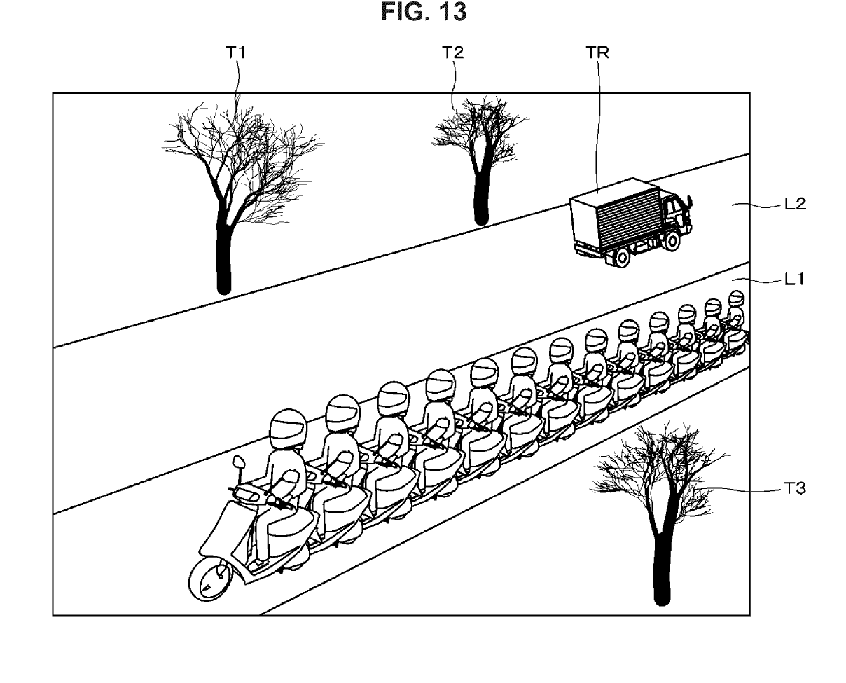

The trajectory composite portion 140 compares the moving subject region information IF₂ supplied from the moving subject tracking portion 130 and the moving subject region information IF₁ supplied from the trajectory composite result holding portion 150. As shown in FIG. 11, a position (X₂, Y₂) and a size (W₂, H₂) that are indicated by the moving subject region information IF₂ are supplied from the moving subject tracking portion 130. The moving subject region information IF₁ supplied from the trajectory composite result holding portion 150 is used as a reference (ref). That is, the reference (ref) in a position (Xref, Yref) and of a size (Wref, Href) is 1 in this processing.

The trajectory composite portion 140 determines whether or not Expression (1) is satisfied, based on the moving subject region information IF₁ and the moving subject region information IF₂.

(Xₙ−Xref)²+(Yₙ−Yref)²>=(Wₙ/2)²+(Hₙ/2)²+(Wref/2)²+(Href/2)² (1)

n=2 because the processing is for the frame image I₂. The left side in Expression (1) indicates a distance between the moving subjects. (Wref/2)²+(Href/2)² indicates the radius of a circle circumscribing the moving subject region of the moving subject region information IF₁. (W₂/2)²+(H₂/2)² indicates the radius of a circle circumscribing the moving subject region of the moving subject region information IF₂. In other words, when Expression (1) is satisfied, the two circumscribing circles come into contact with or separate from each other, and this means that the two moving subject regions do not overlap with each other.

When Expression (1) is not satisfied, the trajectory composite portion 140 discards the frame image I₂ and the moving subject region information IF₁ that are supplied from the moving subject detection portion 120. Then, the next frame image I₃ is read out from the input image holding portion 100. Thereafter, the same processing as that performed on the frame image I₂ is performed on the frame image I₃.

It is assumed that the processing proceeds and, for example, in the processing on the 90^{th} frame image I₉₀, a result that satisfies Expression (1) is obtained. In this case, the trajectory composite portion 140 supplies, to the trajectory composite result holding portion 150, the frame image I₉₀ supplied from the moving subject detection portion 120 and moving subject region information IF₉₀ supplied from the moving subject tracking portion 130.

The trajectory composite result holding portion 150 holds the supplied frame image I₉₀ and the supplied moving subject region information IF₉₀, and updates the reference frame to the frame image I₉₀. For example, at a timing at which the reference frame is updated, the trajectory composite portion 140 composites the frame image I₁ and the frame image I₉₀.

The trajectory composite portion 140 sets the opacity of the frame image I₁ to 0 except the region designated by the moving subject region information IF₁. In the same manner, the trajectory composite portion 140 sets the opacity of the frame image I₉₀ to 0 except the region designated by the moving subject region information IF₉₀. The two frame images (layers) are composited and the moving subject is arranged in the frame. Then, the background is assigned to the region other than the arranged moving subject. For example, the region determined as the background in the frame image I₉₀ is used as the background at this time.

The image obtained by compositing the frame image I₁ and the frame image I₂ is referred to as a composite image A, as appropriate. The composite image A is held in the trajectory composite result holding portion 150. Note that the processing of compositing two frame images is not limited to the above-described processing.

In this manner, the trajectory composite portion 140 compares the moving subject region information of the reference frame and the moving subject region information of the comparison target frame image. Only when the comparison result satisfies Expression (1), the comparison target frame image and the moving subject region information of this frame image are held in the trajectory composite result holding portion 150, and this frame image is set as the reference frame.

In the next processing, the frame image I₉₁ is read out from the input image holding portion 100. A moving subject estimation map M₉₁ is acquired by the processing in the pixel selection portion 110 and the moving subject detection portion 120. Moving subject region information IF₉₁ is acquired by the processing in the moving subject tracking portion 130. The trajectory composite portion 140 determines whether or not the result satisfies Expression (1), based on the moving subject region information IF₉₀ and the moving subject region information IF₉₁.

For example, it is assumed that, in the processing for the frame image I₁₇₀, a result that satisfies Expression (1) is obtained. In this case, the trajectory composite portion 140 supplies the frame image I₁₇₀ and moving subject region information IF₁₇₀ to the trajectory composite result holding portion 150. The reference frame is updated to the frame image I₁₇₀, and the frame image I₁₇₀ and the moving subject region information IF₁₇₀ are supplied to the trajectory composite result holding portion 150. The frame image I₁₇₀ and the moving subject region information IF₁₇₀ are held in the trajectory composite result holding portion 150.

For example, at a timing at which the reference frame is updated, the trajectory composite portion 140 composites the frame image I₁₇₀ with respect to the composite image A. For example, a region indicated by the moving subject region information IF₁₇₀ is extracted from the frame image I₁₇₀. An image of the extracted region is superimposed on the composite image A. For example, in the composite image A, the opacity of the region indicated by the moving subject region information IF₁₇₀ is minimized. The image of the region extracted from the frame image IF₁₇₀ is assigned to the region with the minimum opacity.

The above-described processing is performed on all the frame images held in the input image holding portion 100. The processing of compositing the images is performed at a timing at which the reference frame is updated. When the processing is completed for all the frame images, the trajectory composite portion 140 outputs a composite image at that point in time as a trajectory composite image. The output trajectory composite image is displayed on the trajectory composite image display portion 160.

Note that the timing at which the trajectory composite portion 140 performs the processing of compositing the images is not limited to the timing at which the reference frame is updated. For example, even when the reference frame is updated, the trajectory composite result holding portion 150 may hold the frame image corresponding to the reference frame before the update. After the processing is completed for all the frame images held in the input image holding portion 100, the trajectory composite portion 140 may composite the frame images held in the trajectory composite result holding portion 150 and thereby generate a trajectory composite image.

FIG. 12 shows an example of a trajectory composite image. Images (a motorcycle B10, a motorcycle B11, a motorcycle B12, a motorcycle B13, a motorcycle B14 and a motorcycle B15) on a trajectory of the motorcycle B, and a still image are composited and displayed. The still image includes the background and the unselected moving subject (the truck TR).

Note that the following display may be performed on the trajectory composite image display portion 160. Firstly, the first frame image is supplied to the trajectory composite image display portion 160 and displayed. The composite images composited by the trajectory composite portion 140 are sequentially supplied to the trajectory composite image display portion 160. The composite image displayed on the trajectory composite image display portion 160 is switched and displayed. Due to this processing, display can be performed, for example, such that the motorcycles B (the motorcycle B10, the motorcycle B11, the motorcycle B12 and so on) are sequentially added. Although the position of the truck TR may change, images on a trajectory of the truck TR are not displayed.

In this manner, in the first embodiment, the images on the trajectory of the moving subject selected by the user are displayed. Therefore, the images on the trajectory of a desired moving subject can be displayed. For example, on an image of a soccer game, images on a trajectory of a desired player only or a ball only can be displayed.

Further, in the first embodiment, the frame images etc. are held when Expression (1) is satisfied and the moving subjects do not overlap with each other. Therefore, in the trajectory composite image, the moving subjects in the images on the trajectory do not overlap with each other, and the moving subjects are displayed at an appropriate positional interval. Further, the moving subjects are detected from the frame images. It is not necessary to separately capture an image of only the background to detect the moving subjects, and thus there is no need to perform an image capturing operation a plurality of times.

In contrast to this, in a technology generally used, frame images are held at a certain interval and the held frame images are composited. For example, the frame image is held every 50 frames and the held frame images are composited.

However, the shape, the size and the speed of the moving subject differ depending on whether the moving subject is a motorcycle, a truck, a person, a ball or the like, and the certain interval (50 frames) is not necessarily an appropriate interval. Therefore, there is a possibility that the moving subjects are linearly and continuously displayed in an overlapping manner as shown in FIG. 13 and an unnatural trajectory composite image is obtained. Conversely, there is also a possibility that the interval between the moving subjects in the trajectory composite image is excessively large and an unnatural trajectory composite image is obtained.

The user may change the interval to hold the frame images in accordance with the shape etc. of the moving subject. However, a high level of skill is necessary for the user to set an appropriate interval in accordance with the shape etc. of the moving subject. Therefore, it is very difficult for the user to set an appropriate interval in accordance with the shape etc. of the moving subject. In the first embodiment, the frame images are held when the moving subjects do not overlap with each other. Therefore, the moving subjects on the trajectory do not overlap with each other. Further, it is sufficient for the user to just select a desired moving subject and it is not necessary to perform complex settings. Further, since the moving subject estimation map is used, the moving subject can be easily detected and, at the same time, detection accuracy can be improved.

### 2. SECOND EMBODIMENT

Next, a second embodiment of the present disclosure will be explained. A configuration of an imaging device of the second embodiment is substantially the same as the configuration of the imaging device of the first embodiment, for example. In the second embodiment, part of the processing by the image processing portion 23 differs.

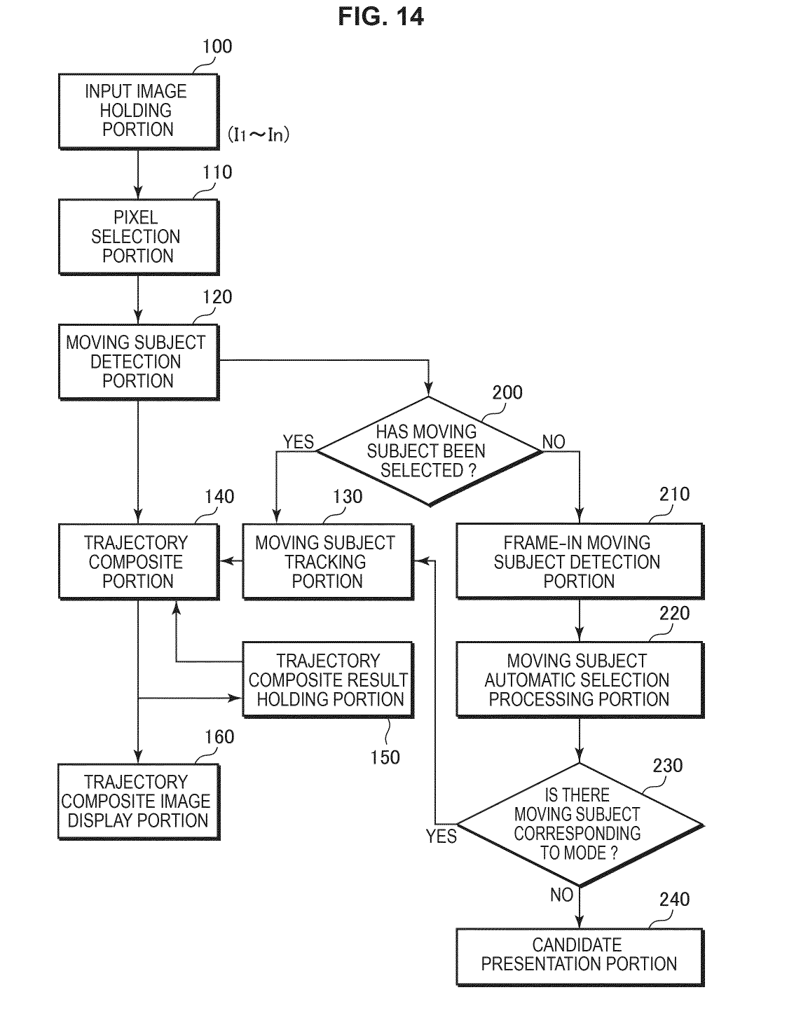

FIG. 14 is a functional block diagram showing an example of functions of the image processing portion 23 according to the second embodiment. The processing performed by each of the input image holding portion 100, the pixel selection portion 110, the moving subject detection portion 120, the moving subject tracking portion 130, the trajectory composite portion 140, the trajectory composite result holding portion 150 and the trajectory composite image display portion 160 is described above, and a redundant explanation thereof is omitted as appropriate.

The image processing portion 23 according to the second embodiment performs determination processing 200 in which it is determined whether or not the moving subject has already been selected. For example, the GUI shown in FIG. 8 or FIG. 9 is used, and when the moving subject has already been selected, a positive result is obtained by the determination processing 200. When the positive result is obtained by the determination processing 200, the same processing as that of the first embodiment is performed. For example, if the motorcycle B has been selected as the moving subject, a trajectory composite image in which images on the trajectory of the motorcycle B are displayed is generated. The trajectory composite image is displayed on the trajectory composite image display portion 160.

When the moving subject has not been selected, a negative result is obtained by the determination processing 200. When the negative result is obtained by the determination processing 200, the moving subject is automatically selected. For example, the moving subject that enters the frame image from outside the frame image is selected with priority (a frame-in moving subject priority selection mode). The selected moving subject is set as a tracking target in the processing performed by the moving subject tracking portion 130.

An example of the frame-in moving subject priority selection mode will be explained. The moving subject estimation map obtained by the processing performed by the moving subject detection portion 120 is supplied to a frame-in moving subject detection portion 210. The frame-in moving subject detection portion 210 sets a detection area, for example, in the vicinity of a corner or in the vicinity of an end portion of the moving subject estimation map M₁. The detection area does not change. At this time, the frame-in moving subject detection portion 210 acquires moving subject region information of moving subjects that exist in the moving subject estimation map M₁, namely, a plurality of moving subjects that exist from the beginning of the image capture.

The frame-in moving subject detection portion 210 analyzes the moving subject estimation maps from the second one onwards, and monitors whether or not a moving subject exists in the detection area. When a moving subject exists in the detection area, the frame-in moving subject detection portion 210 refers to the moving subject region information of the moving subjects that exist from the beginning, and determines whether or not the moving subject that exists in the detection area is one of the moving subjects that exist from the beginning. Here, when the moving subject that exists in the detection area is one of the moving subjects that exist from the beginning, the frame-in moving subject detection portion 210 continues to monitor whether or not a moving subject exists in the detection area.

When the moving subject in the detection area is not one of the moving subjects that exist from the beginning, the frame-in moving subject detection portion 210 determines that a new moving subject has entered the frame. The frame-in moving subject detection portion 210 acquires moving subject region information of the new moving subject. The acquired moving subject region information is supplied to a moving subject automatic selection processing portion 220.

The moving subject automatic selection processing portion 220 sets the new moving subject that has entered the frame as a tracking target moving subject. When the tracking target moving subject is set, it is determined by determination processing 230 that the moving subject corresponding to the frame-in moving subject priority selection mode exists. Information of the moving subject selected by the moving subject automatic selection processing portion 220 is supplied to the moving subject tracking portion 130. The same processing as that explained in the first embodiment is performed on the moving subject selected by the moving subject automatic selection processing portion 220. For example, the processing is started such that the frame image in which the new moving subject is detected is set as the first frame image, and images on a trajectory of the new moving subject and a still image are composited.

When all the moving subject estimation maps have been analyzed, if there is no moving subject that has entered the frame, it is determined by the determination processing 230 that there is no moving subject corresponding to the frame-in moving subject priority selection mode. In this case, processing is performed by a candidate presentation portion 240. The candidate presentation portion 240 performs the processing that displays the moving subjects detected by the moving subject detection portion 120. Since the moving subject candidates are displayed, it is possible to prompt the user to select the moving subject. The GUI shown in FIG. 8 or FIG. 9 may be displayed on a screen that is displayed by the processing performed by the candidate presentation portion 240. When no moving subject is selected, an error may be displayed or the processing that generates a trajectory composite image may be ended.

Note that, although the moving subject that enters the frame is selected with priority in the above-described example, another moving subject may be selected with priority. For example, the first (any order is possible) moving subject estimation map M₁ is supplied to the moving subject automatic selection processing portion 220. The moving subject automatic selection processing portion 220 uses the moving subject estimation map M₁ to detect position information of each of the moving subjects. The position information of each of the moving subjects is indicated, for example, by the coordinates of the center of gravity of the moving subject region. Based on the position information of each of the moving subjects, the moving subject automatic selection processing portion 220 may select the moving subject that is located closest to the center of the frame image, for example (a central moving subject priority selection mode). The selected moving subject is set as a tracking target.

The moving subject automatic selection processing portion 220 may use the moving subject estimation map M₁ to detect size information of each of the moving subjects. The size information of each of the moving subjects is defined by the number of pixels in the moving subject region or a size of a rectangle or a circle that is set to contain the moving subject region. Based on the size information of each of the moving subjects, the moving subject automatic selection processing portion 220 may select the moving subject having a maximum size with priority (a maximum size moving subject priority selection mode). The selected moving subject is set as a tracking target.

Note that the user may be allowed to select a desired mode, from among the plurality of modes described above (i.e., the frame-in moving subject priority selection mode, the central moving subject priority selection mode and the maximum size moving subject priority selection mode). Further, in the determination processing 230, when the moving subject corresponding to a predetermined mode does not exist, another mode may be presented by the candidate presentation portion 240. In the processing to automatically select the moving subject, a plurality of moving subjects may be selected.

### 3. THIRD EMBODIMENT

Next, a third embodiment will be explained. In the third embodiment, a configuration of an imaging device is substantially the same as that of the above-described first or second embodiment. In the third embodiment, some of the functions of the image processing portion 23 differ.

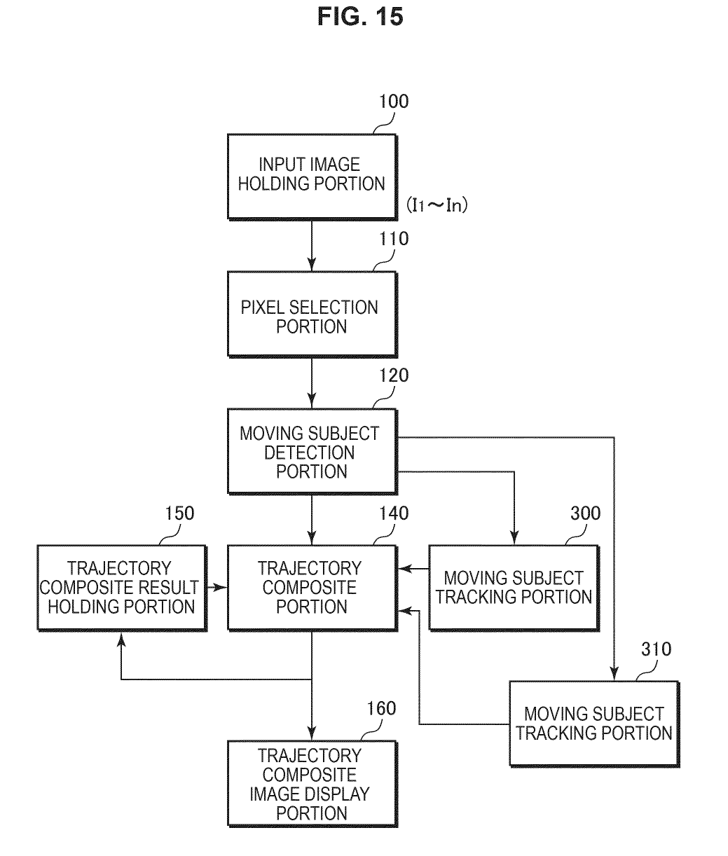

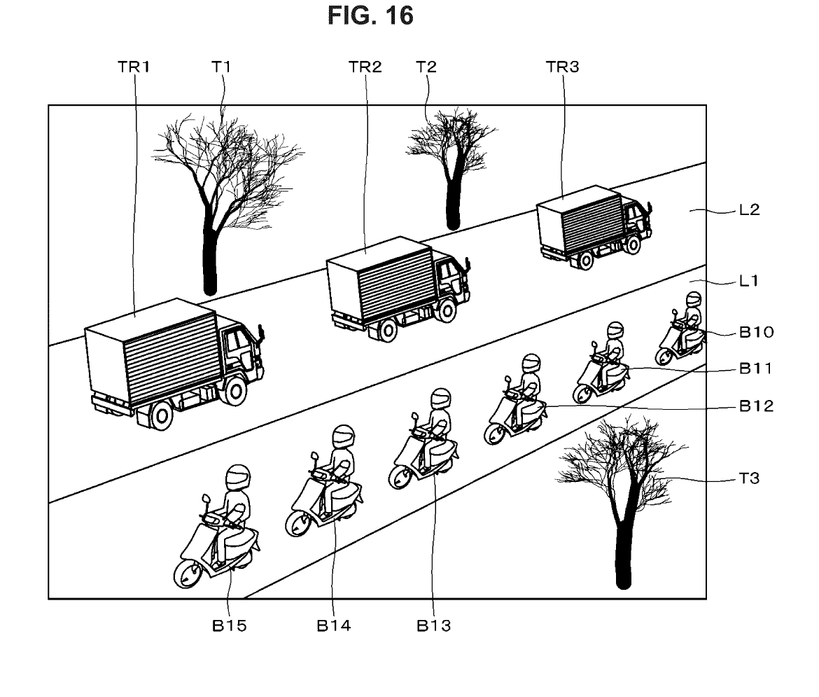

FIG. 15 is a functional block diagram showing an example of functions of the image processing portion 23 according to the third embodiment. Note that the same structural elements (functions) as those of the first embodiment are denoted with the same reference numerals and a redundant explanation thereof is omitted as appropriate.

In the third embodiment, a plurality of moving subjects are selected as tracking targets. For example, in the image shown in FIG. 3, the motorcycle B and the truck TR are selected as the moving subjects. Note that the motorcycle B and the truck TR may be selected by the user or may be selected automatically. The processing on the plurality of selected moving subjects is performed in parallel.

A plurality of frame images are held in the input image holding portion 100. The processing by the pixel selection portion 110 and the moving subject detection portion 120 is the same as that in the first embodiment. For example, the moving subject estimation map M₁ is acquired by the processing that is performed on the first frame image I₁ by the moving subject detection portion 120. The moving subject estimation map M₁ is supplied to a moving subject tracking portion 300 and a moving subject tracking portion 310. The moving subject tracking portion 300 refers to the moving subject estimation map M₁ and thereby acquires moving subject region information IFB₁ of the motorcycle B. The moving subject tracking portion 310 refers to the moving subject estimation map M₁ and thereby acquires moving subject region information IFTR₁ of the truck TR.

The moving subject region information IFB₁ and the moving subject region information IFTR₁ are supplied to the trajectory composite portion 140. Further, the frame image I₁ is supplied to the trajectory composite portion 140. The trajectory composite portion 140 supplies the frame image I₁, the moving subject region information IFB₁ and the moving subject region information IFTR₁ to the trajectory composite result holding portion 150. The frame image I₁, the moving subject region information IFB₁ and the moving subject region information IFTR₁ are held in the trajectory composite result holding portion 150.

Next, the frame image I₂ is read out from the input image holding portion 100. The processing by the pixel selection portion 110 and the moving subject detection portion 120 is performed on the frame image I₂, and the moving subject estimation map M₂ is obtained. The moving subject estimation map M₂ is supplied to the moving subject tracking portion 300 and the moving subject tracking portion 310. The frame image I₂ is supplied to the trajectory composite portion 140.

The moving subject tracking portion 300 refers to the moving subject estimation map M₂ and thereby acquires moving subject region information IFB₂ of the motorcycle B. The moving subject tracking portion 310 refers to the moving subject estimation map M₂ and thereby acquires moving subject region information IFTR₂ of the truck TR. The moving subject region information IFB₂ and the moving subject region information IFTR₂ are supplied to the trajectory composite portion 140.

The trajectory composite portion 140 performs determination processing using the above-described Expression (1), for each of the moving subjects. For example, as the determination processing relating to the motorcycle B, determination processing to determine whether or not Expression (1) is satisfied is performed based on the moving subject region information IFB₁ and the moving subject region information IFB₂. In the determination processing relating to the motorcycle B, the moving subject region information IFB₁ is used as ref in Expression (1).

Further, as the determination processing relating to the truck TR, determination processing to determine whether or not Expression (1) is satisfied is performed based on the moving subject region information IFTR₁ and the moving subject region information IFTR₂. In the determination processing relating to the truck TR, the moving subject region information IFTR₁ is used as ref in Expression (1).

When Expression (1) is not satisfied in both the determination processing relating to the motorcycle B and the determination processing relating to the truck TR, the frame image I₂, the moving subject region information IFB₂ and the moving subject region information IFTR₂ are discarded. Then, the frame image I₃ is read out from the input image holding portion 100, and processing that is the same as that performed on the frame image I₂ is performed.

It is assumed that a result that satisfies Expression (1) is obtained in at least one of the determination processing relating to the motorcycle B or the determination processing relating to the truck TR. For example, it is assumed that, with respect to the processing for the frame image I₉₀, a result that satisfies Expression (1) is obtained in the determination processing relating to the motorcycle B and a result that does not satisfy Expression (1) is obtained in the determination processing relating to the truck TR.

The trajectory composite portion 140 causes the trajectory composite result holding portion 150 to hold moving subject region information IFB₉₀ obtained from the frame image I₉₀. The moving subject region information IFB₉₀ is used as ref in the determination processing relating to the motorcycle B. Note that the moving subject region information IFTR₉₀ is discarded, and the moving subject region information IFTR₁ held in the trajectory composite result holding portion 150 is not updated.

The trajectory composite portion 140 further composites the frame image I₁ and a part of the comparison target frame image I₉₀ and thereby generates a composite image (hereinafter referred to as a composite image B). The composite image B is held in the trajectory composite result holding portion 150, for example.

The composite image B is generated, for example, in the following manner. The trajectory composite portion 140 extracts, from the frame image I₉₀, an image of a region indicated by the moving subject region information IFB₉₀. Then, the trajectory composite portion 140 superimposes the extracted image on the frame image I₁ at a position that corresponds to the moving subject region information IFB₉₀.

Then, the same processing is sequentially performed on the frame images from the frame image I₉₁ onwards. Here, it is assumed that, with respect to the processing from the frame image I₉₁ to the frame image I₁₅₉, there is no result that satisfies Expression (1) in both the determination processing relating to the motorcycle B and the determination processing relating to the truck TR.

Next, the processing is performed on the frame image I₁₆₀. For example, as the determination processing relating to the motorcycle B, the trajectory composite portion 140 performs the determination processing to determine whether or not Expression (1) is satisfied, based on the moving subject region information IFB₉₀ and moving subject region information IFB₁₆₀. The moving subject region information IFB₉₀ is used as ref in the determination processing that uses Expression (1).

Further, as the determination processing relating to the truck TR, the determination processing to determine whether or not Expression (1) is satisfied is performed based on the moving subject region information IFTR₁ and moving subject region information IFTR₁₆₀. The moving subject region information IFTR₁ is used as ref in the determination processing that uses Expression (1).

It is assumed that a result that does not satisfy Expression (1) is obtained in the determination processing relating to the motorcycle B, and a result that satisfies Expression (1) is obtained in the determination processing relating to the truck TR.

The trajectory composite portion 140 causes the trajectory composite result holding portion 150 to hold the moving subject region information IFTR₁₆₀. The moving subject region information IFTR₁₆₀ is used as ref in the subsequent determination processing relating to the truck TR. Note that the moving subject region information IFB₉₀ held in the trajectory composite result holding portion 150 is not updated. The moving subject region information IFB₁₆₀ is discarded.

The trajectory composite portion 140 further composites the composite image B and a part of the frame image I₁₆₀ and thereby generates a composite image (hereinafter referred to as a composite image C). The composite image C is held in the trajectory composite result holding portion 150, for example.

The composite image C is generated, for example, in the following manner. The trajectory composite portion 140 extracts, from the frame image I₁₆₀, an image of a region indicated by the moving subject region information IFTR₁₆₀. Then, the trajectory composite portion 140 superimposes the extracted image on the composite image B at a position that corresponds to the moving subject region information IFTR₁₆₀. The composite image C is held in the trajectory composite result holding portion 150.

After that, the same processing is sequentially performed and the processing is complete for all the frame images. The composite image that is held in the trajectory composite result holding portion 150 when the processing is complete is taken as the trajectory composite image. The trajectory composite portion 140 supplies the trajectory composite image to the trajectory composite image display portion 160. The trajectory composite image is displayed on the trajectory composite image display portion 160.

FIG. 16 shows an example of a trajectory composite image according to the third embodiment. Images (the motorcycle B10, the motorcycle B11 . . . the motorcycle B15) on the trajectory of the motorcycle B are displayed on the trajectory composite image. The respective motorcycles B are displayed such that they do not overlap with each other. In addition, images (a truck TR1, a truck TR2, a truck TR3) on the trajectory of the truck TR are displayed on the trajectory composite image. The respective trucks TR are displayed such that they do not overlap with each other.

It is assumed that, for example, an interval between the center of gravity of the motorcycle B10 and the center of gravity of the motorcycle B11 (an interval between the motorcycles) is different from an interval between the center of gravity of the truck TR1 and the center of gravity of the truck TR2 (an interval between the trucks). In a case where frame images are held at a certain frame interval, the interval between the motorcycles is equal to the interval between the trucks. As a result, for example, even if the interval between the motorcycles is appropriate, there is a possibility that the trucks TR are displayed such that they overlap with each other and an unnatural trajectory composite image is generated.

If the determination processing using Expression (1) is performed for each of the moving subjects, it is possible to set the interval between the motorcycles B in the images on the trajectory to an appropriate interval. At the same time, it is possible to set the interval between the trucks TR in the images on the trajectory to an appropriate interval. Note that three or more moving subjects may be selected as a plurality of moving subjects. In this case, the moving subject tracking portions, the number of which corresponds to the number of the moving subjects, function and the same processing as that described above is performed.

As explained above, in the third embodiment, when a plurality of moving subjects are selected, the determination processing using Expression (1) is performed for each of the moving subjects. Then, ref that is used in Expression (1) is updated for each of the moving subjects.

Note that the following processing can also be performed. For example, a trajectory composite image relating to the motorcycle B and a trajectory composite image relating to the truck TR are respectively generated. The trajectory composite image relating to the motorcycle B and the trajectory composite image relating to the truck TR may be composited and thus a final trajectory composite image may be generated. The final trajectory composite image is displayed on the trajectory composite image display portion 160.

Further, the processing in the third embodiment need not necessarily be limited to parallel processing. For example, firstly, the trajectory composite image relating to the motorcycle B is generated by performing the processing that is the same as the processing in the first embodiment. Further, the trajectory composite image relating to the truck TR is generated by performing the processing that is the same as the processing in the first embodiment. The trajectory composite image relating to the motorcycle B and the trajectory composite image relating to the truck TR may be composited and thus a final trajectory composite image may be generated. The final trajectory composite image is displayed on the trajectory composite image display portion 160.

### 4. MODIFIED EXAMPLES

Hereinabove, the embodiments of the present disclosure are explained. However, the present disclosure is not limited to the above-described embodiments and various modifications are possible.

In the above-described plurality of embodiments, the plurality of moving subjects in the images on the trajectory do not overlap with each other. However, the moving subjects may partially overlap with each other. Further, the interval between the moving subjects in the images on the trajectory may be widened.

For example, Expression (1) that is used in the processing of the trajectory composite portion 140 is modified to Expression (2).

(Xₙ−Xref)²+(Yₙ−Yref)²+α>=(Wₙ/2)²+(Hₙ/2)²+(Wref/2)²+(Href/2)² (2)

When α=0 in Expression (2), Expression (2) is equivalent to Expression (1). If the value of α is set to a negative value, the moving subjects in the images on the trajectory can be overlapped with each other. Further, if the value of α is set to a negative value and also the absolute value of α is increased, it is possible to increase the degree of overlap (an overlapping manner) of the moving subjects. Conversely, if the value of α is set to a positive value and the value of α is increased, it is possible to increase the interval between the moving subjects in the images on the trajectory.

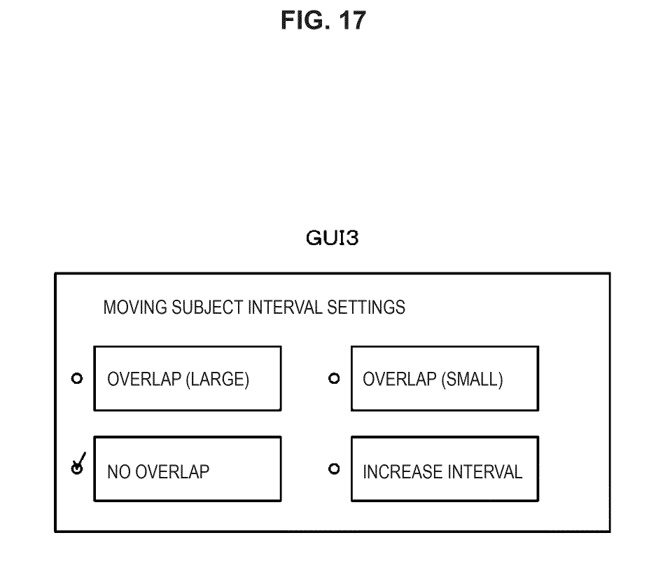

The user may be allowed to select the overlapping manner of the moving subjects in the images on the trajectory, and the interval between the moving subjects in the images on the trajectory. For example, a graphical user interface GUI3 shown in FIG. 17 may be used to set the interval between the moving subjects. In the graphical user interface GUI3, the setting is made such that the moving subjects do not overlap with each other, as explained in the first embodiment etc. In this case, α=0 is set. For example, if “OVERLAP (LARGE)” is selected, a is set to a large negative value. If “OVERLAP (SMALL)” is selected, α is set to a small negative value. If “INCREASE INTERVAL” is selected, α is set to a positive value. The value of α is set appropriately in accordance with a size of the trajectory composite image display portion 160, or the like.

Further, for example, a slide key may be used to adjust the overlapping manner of the moving subjects in the images on the trajectory. For example, the adjustment may be performed such that, when the slide key is caused to slide toward the right, the value of α is continuously increased, and when the slide key is caused to slide toward the left, the value of α is continuously reduced. Depending on the moving subject, it may be preferable that the moving subjects on the trajectory partially overlap. Further, depending on the moving subject, it may be preferable that the interval between the moving subjects on the trajectory is large. Also in these types of cases, an appropriate trajectory composite image can be obtained just by performing a simple setting.

Expression (1) or Expression (2) need not necessarily be used in the processing of the trajectory composite portion 140. In other words, the distance between the moving subject in the reference frame and the moving subject in the comparison target frame need not necessarily be taken into account.

For example, the region (the white region in the moving subject estimation map) indicating the moving subject in the reference frame and the region indicating the moving subject in the comparison target frame image are extracted. The respective regions are compared, and the number of pixels that are common to both the regions is obtained. The larger the number of the pixels that are common to both the regions, the greater the degree of overlap of the two moving subjects.

A threshold value is set for the number of the pixels. When the number of the pixels exceeds the threshold value, the trajectory composite portion 140 may perform the processing to composite images or the processing to update the reference frame. For example, when the threshold value is set to 0, the processing is equivalent to the processing that is performed when α=0 in Expression (2). When the threshold value is increased, the processing is equivalent to the processing that is performed when the value of α is set to a negative value and the absolute value of α is increased. Instead of using the number of the pixels, a ratio of the number of pixels with respect to the region indicating the moving subject may be used. According to the modified example, for example, even when only a part of the moving subject moves (for example, a person does not move any distance and changes his/her posture only), it is possible to generate images on the trajectory.

The above-described processing need not necessarily be performed on all the frame images. For example, the processing may be performed after a predetermined number of frames are thinned out from the 600 frames held in the input image holding portion 100. The numeric values (the order of the frame images, for example) and the like in the above-described explanation are used as examples to facilitate understanding, and the content of the present disclosure is not limited to those numeric values and the like.

The present disclosure is not limited to an imaging device, and can be configured as an image processing device that has at least the functions of the image processing portion. The image processing device is realized by a personal computer, a mobile terminal, a video camera or the like. Further, the image processing device may have a communication function that transmits a trajectory composite image to another device. Further, the image processing device may be configured as a broadcasting device. For example, immediately after broadcasting a goal scene in a soccer game, images on a trajectory of a ball going into the goal can be broadcasted, instead of slowly playing back the goal scene.

Further, the present disclosure is not limited to a device, and may be realized as a program and a recording medium.

Note that the configurations and the processing in the embodiments and the modified examples can be combined as appropriate, as long as a technical inconsistency does not occur. The order of each of the processes in the illustrated processing flow can be changed as appropriate, as long as a technical inconsistency does not occur.

The present disclosure can be applied to a so-called cloud system in which the processing described above is distributed and performed by a plurality of devices. For example, the respective functions of the moving subject detection portion, the moving subject tracking portion and the trajectory composite portion may be performed by different devices. The present disclosure can be realized as a device that performs at least part of the functions described above.

Additionally, the present technology may also be configured as below.
(1) An image processing device, wherein

the image processing device detects a plurality of moving subjects from a plurality of frames captured at a predetermined timing,

the image processing device selects a predetermined moving subject from the detected plurality of moving subjects, and

the image processing device composites images on a trajectory of the selected moving subject and a still image.
(2) The image processing device according to (1), wherein

the selection is performed by designating a region that corresponds to each of the plurality of moving subjects.
(3) The image processing device according to (1) or (2), wherein

the moving subject included in each of the images on the trajectory is determined in accordance with a positional relationship between the selected moving subject in a reference frame and the selected moving subject in a comparison target frame.
(4) The image processing device according to (3), wherein

the positional relationship is a positional relationship in which the moving subject in the reference frame and the moving subject in the comparison target frame do not overlap with each other.
(5) The image processing device according to (1), wherein

the image processing device selects a plurality of moving subjects, and

the image processing device composites images on a trajectory of each of the plurality of moving subjects and the still image.
(6) The image processing device according to (5), wherein

an interval between moving subjects in images on a trajectory of a predetermined one of the moving subjects, and an interval between moving subjects in images on a trajectory of another of the moving subjects are set to different intervals.
(7) The image processing device according to any one of (1) to (6), wherein

a predetermined moving subject is automatically selected.
(8) The image processing device according to any one of (1) to (7), wherein

the image processing device generates binary information by binarizing each of the plurality of frames, and

the image processing device detects the plurality of moving subjects in accordance with the binary information.
(9) The image processing device according to any one of (1) to (8), wherein

the image processing device has an imaging portion that captures the plurality of frames.
(10) An image processing method, used in an image processing device, including:

detecting a plurality of moving subjects from a plurality of frames captured at a predetermined timing;

selecting a predetermined moving subject from the detected plurality of moving subjects; and compositing images on a trajectory of the selected moving subject and a still image.
(11) A program for causing a computer to perform an image processing method, used in an image processing device, including:

detecting a plurality of moving subjects from a plurality of frames captured at a predetermined timing;

selecting a predetermined moving subject from the detected plurality of moving subjects; and

compositing images on a trajectory of the selected moving subject and a still image.
(12) A recording medium having the program according to (11) recorded therein.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2012-022834 filed in the Japan Patent Office on Feb. 6, 2012, the entire content of which is hereby incorporated by reference.

What is claimed is:

1. An image processing device, wherein
the image processing device detects a plurality of moving subjects from a plurality of frames captured at a predetermined timing,
the image processing device selects a predetermined moving subject from the detected plurality of moving subjects, and
the image processing device composites images on a trajectory of the selected moving subject and a still image.

2. The image processing device according to claim 1, wherein
the selection is performed by designating a region that corresponds to each of the plurality of moving subjects.

3. The image processing device according to claim 1, wherein
the moving subject included in each of the images on the trajectory is determined in accordance with a positional relationship between the selected moving subject in a reference frame and the selected moving subject in a comparison target frame.

4. The image processing device according to claim 3, wherein
the positional relationship is a positional relationship in which the moving subject in the reference frame and the moving subject in the comparison target frame do not overlap with each other.

5. The image processing device according to claim 1, wherein
the image processing device selects a plurality of moving subjects, and
the image processing device composites images on a trajectory of each of the plurality of moving subjects and the still image.

6. The image processing device according to claim 5, wherein
an interval between moving subjects in images on a trajectory of a predetermined one of the moving subjects, and an interval between moving subjects in images on a trajectory of another of the moving subjects are set to different intervals.

7. The image processing device according to claim 1, wherein
a predetermined moving subject is automatically selected.

8. The image processing device according to claim 1, wherein
the image processing device generates binary information by binarizing each of the plurality of frames, and
the image processing device detects the plurality of moving subjects in accordance with the binary information.

9. The image processing device according to claim 1, wherein
the image processing device has an imaging portion that captures the plurality of frames.

10. An image processing method, used in an image processing device, comprising:
detecting a plurality of moving subjects from a plurality of frames captured at a predetermined timing;
selecting a predetermined moving subject from the detected plurality of moving subjects; and
compositing images on a trajectory of the selected moving subject and a still image.

11. A program for causing a computer to perform an image processing method, used in an image processing device, comprising:
detecting a plurality of moving subjects from a plurality of frames captured at a predetermined timing;
selecting a predetermined moving subject from the detected plurality of moving subjects; and
compositing images on a trajectory of the selected moving subject and a still image.

12. A recording medium having the program according to claim 11 recorded therein.
